(19) United States
(12) Patent Application Publication
(10) Pub. No.: US 2024/0011654 A1
(43) Pub. Date: Jan. 11, 2024

(54) ELECTROSTATIC PRECIPITATOR, INDOOR UNIT, AND AIR CONDITIONER

(71) Applicant: Mitsubishi Electric Corporation, Tokyo (JP)

(72) Inventors: Yo MATSUDA, Tokyo (JP); Shuhei TOMITA, Tokyo (JP); Shoya KUSUMOTO, Tokyo (JP); Takeshi KAWAMURA, Tokyo (JP)

(21) Appl. No.: 18/257,376

(22) PCT Filed: Apr. 2, 2021
(86) PCT No.: PCT/JP2021/014312

§ 371 Date: Jun. 14, 2023

(51) Int. Cl. F24F 8/192; B03C 3/82

(52) U.S. Cl. CPC F24F 8/192; B03C 3/82

(57) ABSTRACT

An electrostatic precipitator includes: a casing attached to a housing a fixing member a supporter a device body supported by the supporter and is detachably attached to the supporter; and a hook member supporting the device body. The device body includes a handle protruding in a first direction and a pair of protrusions protruding from both end side surfaces of the delivery body in a second direction, the supporter includes a pair of first support portions respectively supporting the pair of protrusions by hooking the pair of protrusions, the hook member includes a hook portion supporting the handle the handle includes a pair of extending portions protruding in the first direction and a grip portion connecting the extending portions, the hook portion supports the grip portion from below, and the hook member is attached to the supporter so as to be slidable in the first direction.

### CROSS REFERENCE TO RELATED APPLICATION

This application is a U.S. national stage application of International Application No. PCT/JP2021/014312, filed on Apr. 2, 2021, the contents of which are incorporated herein by reference.

### TECHNICAL FIELD

The present disclosure relates to an electrostatic precipitator, an indoor unit, and an air conditioner.

### BACKGROUND

For example, Patent Document 1 discloses an air conditioner including a wall-mounted type indoor unit provided with an electrostatic precipitator. In Patent Document 1, a dust collection unit attachment frame for attaching a dust collection unit thereto is fixed on a front air passage of the indoor unit, and the electrostatic precipitator is detachably attached to the dust collection unit attachment frame.

### PATENT DOCUMENT

### Patent Document 1

Japanese Unexamined Patent Application, First Publication No. 2006-112767

The electrostatic precipitator includes a filter, and the filter needs to be cleaned. In the case of the wall-mounted type indoor unit of Patent Document 1, since an intake air passage is located in front of the indoor unit, the electrostatic precipitator is locked to the front surface of the indoor unit. Therefore, the electrostatic precipitator is stably supported and hardly fall during maintenance of the electrostatic precipitator such as filter cleaning. On the other hand, in the case of a ceiling-embedded type indoor unit, since the intake air passage is located on the lower surface of the indoor unit, the electrostatic precipitator disposed on the intake air passage is also provided on the lower surface of the indoor unit. Therefore, since the components of the electrostatic precipitator are more likely to fall off compared to the wall-mounted type indoor unit during installation or maintenance of the electrostatic precipitator, there was a problem in terms of attachment and detachment workability.

### SUMMARY

The present disclosure has been made in view of the above-described circumstances and an object thereof is to provide an electrostatic precipitator having a structure capable of improving the workability of attaching and detaching a device body to and from an indoor unit, an indoor unit including such an electrostatic precipitator, and an air conditioner including such an indoor unit.

An aspect of an electrostatic precipitator of the present disclosure is an electrostatic precipitator provided in an indoor unit of an air conditioner, including: a casing attached to a housing of the indoor unit; a fixing member attached to the casing; a supporter attached to the fixing member; a device body supported by the supporter and is detachably attached to the supporter; and a hook member supporting the device body, wherein the device body includes a handle protruding in a first direction and a pair of protrusions protruding from both end side surfaces of the delivery body in a second direction orthogonal to the first direction, the supporter includes a pair of first support portions respectively supporting the pair of protrusions by hooking the pair of protrusions, the hook member includes a hook portion supporting the handle, the handle includes a pair of extending portions which protrudes in the first direction and a grip portion which connects the extending portions, the hook portion supports the grip portion from below, and the hook member is attached to the supporter so as to be slidable in the first direction.

An aspect of an indoor unit of the present disclosure includes: a housing; a heat exchanger accommodated in the housing; an air supply mechanism accommodated in the housing; and the electrostatic precipitator which is attached to the housing.

An aspect of an air conditioner of the present disclosure includes: the outdoor unit; and an indoor unit connected to the outdoor unit by a circulation path portion through which a refrigerant circulates.

According to an aspect of the present disclosure, the workability of attaching and detaching the device body to and from the indoor unit in the electrostatic precipitator is capable of being improved.

### BRIEF DESCRIPTION OF DRAWINGS

FIG. 1 is a schematic view showing a schematic configuration of an air conditioner in an embodiment.

FIG. 2 is an exploded perspective view showing a schematic configuration of an indoor unit in the embodiment.

FIG. 3 is an exploded perspective view showing an electrostatic precipitator in the embodiment.

FIG. 4 is a perspective view showing a fixing member in the embodiment.

FIG. 5 is a perspective view showing a device body in the embodiment.

FIG. 6 is a side view showing the device body in the embodiment.

FIG. 7 is a perspective view showing a supporter in the embodiment.

FIG. 8 is a schematic view of a part of the supporter and a part of the fixing member in the embodiment viewed from the front side.

FIG. 9 is a perspective view showing a hook member in the embodiment.

FIG. 10 is a perspective view showing a temporarily fixed state of the device body in the embodiment.

FIG. 11 is a view showing a temporarily fixed state of the device body in the embodiment and is a cross-sectional view taken along a line XI-XI of FIG. 10.

FIG. 12 is a perspective view showing a regular fixed state of the device body in the embodiment.

FIG. 13 is a view showing a regular fixed state of the device body in the embodiment and is a front view when viewed from a direction of an arrow XIII of FIG. 12.

### DETAILED DESCRIPTION

In the following description, directions along the X, Y. and Z axes in the drawings are defined, and each part of an indoor unit 1 is described using each direction. A direction parallel to the X axis is called a “front and rear direction (first direction) X”. A direction parallel to the Y axis is called a “width direction (second direction) Y”. A direction parallel to the Z axis is called a “vertical direction (third direction) Z”. The front and rear direction X, the width direction Y, and the vertical direction Z are directions orthogonal to each other. In the embodiment, in the front and rear direction X, the side indicated by the arrow +X shown in the drawing is called the front side and the side indicated by the arrow −X is called the rear side. In the vertical direction Z, the side indicated by the arrow +Z shown in the drawing is called the upper side and the side indicated by the arrow −Z is called the lower side. The front and rear direction X, the width direction Y, and the vertical direction Z are simply names for describing the arrangement relationship of each part, and the actual arrangement relationship is not limited by these names.

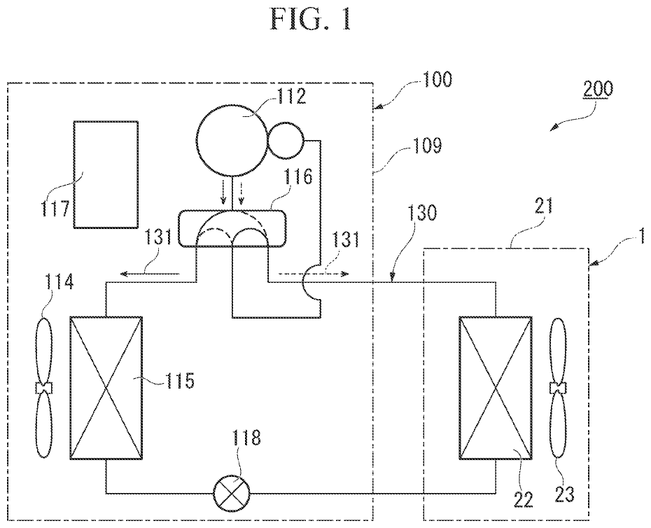

FIG. 1 is a schematic view showing a schematic configuration of an air conditioner 200 in an embodiment. The air conditioner 200 is a device utilizing a refrigeration cycle in which a refrigerant 131 circulates. As shown in FIG. 1, the air conditioner 200 includes an outdoor unit 100, the indoor unit 1, and a circulation path portion 130. The outdoor unit 100 is disposed outdoors. The indoor unit 1 is disposed indoors. The outdoor unit 100 and the indoor unit 1 are connected to each other by the circulation path portion 130. The circulation path portion 130 includes a conduit through which the refrigerant 131 flows between the outdoor unit 100 and the indoor unit 1.

The air conditioner 200 is capable of adjusting the temperature of the indoor air by exchanging heat between the refrigerant 131 flowing through the circulation path portion 130 and the air of the indoor in which the indoor unit 1 is disposed. As the refrigerant 131, for example, a fluorine-based refrigerant or a hydrocarbon-based refrigerant with a low global warming potential (GWP) can be used.

The outdoor unit 100 includes an outdoor unit housing 109, a compressor 112, a heat exchanger 115, a flow control valve 118, a fan 114, a four-way valve 116, and an electrical unit 117. The outdoor unit housing 109 constitutes the outer shell of the outdoor unit 100.

As shown in FIG. 1, the compressor 112, the heat exchanger 115, the flow control valve 118, the fan 114, the four-way valve 116, and the electrical unit 117 are accommodated in the outdoor unit housing 109. The compressor 112, the heat exchanger 115, the flow control valve 118, and the four-way valve 116 are provided in a portion located inside the outdoor unit housing 109 in the circulation path portion 130. The compressor 112, the heat exchanger 115, the flow control valve 118, and the four-way valve 116 are connected to each other by a portion located inside the outdoor unit housing 109 in the circulation path portion 130.

The compressor 112 is capable of compressing the refrigerant 131 having flowed into the compressor 112. The compressor 112 may have any structure if the refrigerant 131 is capable of being compressed. The compressor 112 is, for example, a positive displacement rotary compressor. The refrigerant 131 circulates through the circulation path portion 130 by driving the compressor 112.

The heat exchanger 115 is capable of exchanging heat between the refrigerant 131 flowing through the circulation path portion 130 and the air inside the outdoor unit housing 109.

The flow control valve 118 is capable of adjusting the flow rate of the refrigerant 131 flowing through the circulation path portion 130. The flow control valve 118 is an expansion valve that decompresses the refrigerant 131 flowing through the circulation path portion 130. The flow control valve 118 is capable of adjusting the flow rate of the refrigerant 131 and the pressure of the refrigerant 131 by adjusting the opening degree using, for example, the electrical unit 117. The opening degree of the flow control valve 118 is capable of being adjusted in accordance with, for example, the operation state of the indoor unit 1.

The fan 114 is capable of blowing the air that have exchanged heat with the refrigerant 131 by the heat exchanger 115 to the outside of the outdoor unit 100. The fan 114 sucks air outside the outdoor unit 100 from an air inlet (not shown) provided in the outdoor unit housing 109 into the outdoor unit housing 109. The air sucked into the outdoor unit housing 109 passes through the heat exchanger 115 and is sucked into the fan 114. The fan 114 discharges the sucked air toward the air outlet and sends the air from the air outlet to the outside of the outdoor unit 100. The fan 114 may be any type of fan. The fan 114 is, for example, a propeller fan.

The four-way valve 116 is provided in a portion which is connected to the discharge side of the compressor 112 in the circulation path portion 130. The four-way valve 116 is capable of reversing a direction of the refrigerant 131 flowing through the circulation path portion 130 by switching a part of the circulation path portion 130. In a case that the path connected via the four-way valve 116 is the path indicated by the solid line in the four-way valve 116 of FIG. 1, the refrigerant 131 flows through the circulation path portion 130 in the direction indicated by the solid arrow in FIG. 1. On the other hand, in a case that the path connected via the four-way valve 116 is the path indicated by the dashed line in the four-way valve 116 of FIG. 1, the refrigerant 131 flows through the circulation path portion 130 in the direction indicated by the dashed arrow in FIG. 1.

The electrical unit 117 controls each part of the outdoor unit 100. The electrical unit 117 is, for example, a system control unit that controls the entire air conditioner 200. The electrical unit 117 includes a circuit board.

In the embodiment, the indoor unit 1 can perform a cooling operation of cooling the air of the indoor in which the indoor unit 1 is disposed and a heating operation of heating the air of the indoor in which the indoor unit 1 is disposed. As shown in FIG. 1, the indoor unit 1 includes a housing 21, a heat exchanger 22, and an indoor fan (air supply mechanism) 23. The heat exchanger 22 and the indoor fan 23 are accommodated in the housing 21.

The heat exchanger 22 is provided in a portion, where is located inside the housing 21, in the circulation path portion 130. The heat exchanger 22 is exchangeable heat between the refrigerant 131 flowing through the circulation path portion 130 and the air inside the housing 21. The heat exchanger 22 may have any structure if the heat is capable of being exchanged between the refrigerant 131 and the air inside the housing 21. The structure of the heat exchanger 22 may be the same as the structure of the heat exchanger 115 of the outdoor unit 100 or may be different from the structure of the heat exchanger 115.

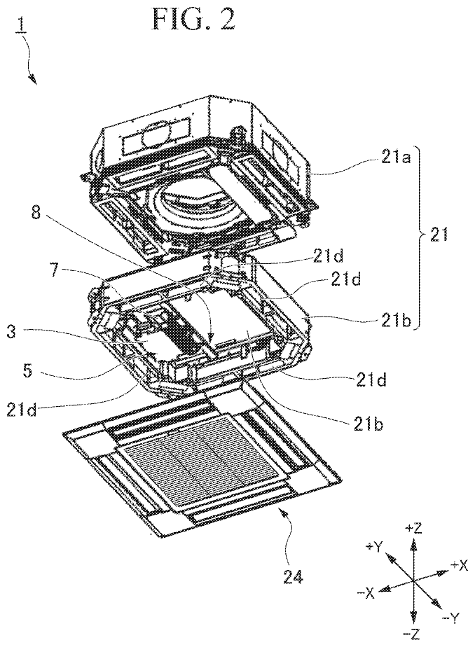

The indoor fan 23 is an air supply mechanism that is capable of blowing the air having exchanged heat with the refrigerant 131 in the heat exchanger 22 to the outside of the indoor unit 1. The indoor fan 23 sucks the indoor air into the housing 21 from an air inlet 21c (see FIG. 2) provided in the housing 21. The air sucked into the housing 21 passes through, for example, the heat exchanger 22 and is sucked into the indoor fan 23. The indoor fan 23 discharges the sucked air toward an air outlet 21d (see FIG. 2) provided in the housing 21 and sends the air from the air outlet 21d to the outside of the indoor unit 1. Accordingly, the air having exchanged heat with the refrigerant 131 by the heat exchanger 22 is blown into the room from the air outlet 21d. The indoor fan 23 may be any type of blower. The indoor fan 23 may be the same kind of fan as the fan 114 of the outdoor unit 100 or may be the different kind of fan from the fan 114. The indoor fan 23 is, for example, a cross flow fan.

When the indoor unit 1 is in the cooling operation, the refrigerant 131 flowing through the circulation path portion 130 flows in the direction indicated by the solid arrow in FIG. 1. That is, when the indoor unit 1 is in the cooling operation, the refrigerant 131 flowing through the circulation path portion 130 flows in the direction to pass through the compressor 112, the heat exchanger 115 of the outdoor unit 100, the flow control valve 118, and the heat exchanger 22 of the indoor unit 1 in this order and to return to the compressor 112. In the cooling operation, the heat exchanger 115 in the outdoor unit 100 functions as a condenser and the heat exchanger 22 in the indoor unit 1 functions as an evaporator.

On the other hand, when the indoor unit 1 is in the heating operation, the refrigerant 131 flowing through the circulation path portion 130 flows in the direction indicated by the dashed line in FIG. 1. That is, when the indoor unit 1 is in the heating operation, the refrigerant 131 flowing through the circulation path portion 130 circulates in the direction to pass through the compressor 112, the heat exchanger 22 of the indoor unit 1, the flow control valve 118, and the heat exchanger 115 of the outdoor unit 100 in this order and to return to the compressor 112. In the heating operation, the heat exchanger 115 in the outdoor unit 100 functions as an evaporator and the heat exchanger 22 in the indoor unit 1 functions as a condenser.

FIG. 2 is an exploded perspective view showing a schematic configuration of the indoor unit 1 in the embodiment. As shown in FIG. 2, in this embodiment, the indoor unit 1 is a ceiling-embedded type indoor unit that can be embedded in the indoor ceiling. The lower portion of the indoor unit 1 is disposed along the indoor ceiling and the upper portion of the indoor unit 1 is embedded in the ceiling and fixed to the ceiling. The housing 21 of the indoor unit 1 includes a body portion 21a which is fixed to the ceiling. The indoor unit 1 includes a casing 21b having a frame-shape and is detachably attached below the body portion 21a. The housing 21 has a substantially prismatic outer shape. A bottom surface of the casing 21b has a substantially octagonal shape with inclined sides at the four corners of the quadrangle in a plan view. The air outlet 21d is formed on the bottom surface of the casing 21b and along four main sides extending in the front and rear direction X and the width direction Y. The air inlet 21c is formed at the center portion of the casing 21b in a plan view. The air outlet 21d and the air inlet 21c open to the interior. The decorative panel 24 is detachably provided on the bottom surface of the casing 21b. The bottom portion of the indoor unit 1 is covered with the decorative panel 24 to allow ventilation and to hide the inside of the housing 21 from being seen.

The indoor unit 1 includes an electrostatic precipitator 3 other than the heat exchanger 22 and the indoor fan 23. The electrostatic precipitator 3 is provided at a position overlapping apart of the air inlet 21c in the vertical direction Z. That is, the electrostatic precipitator 3 is provided on an intake air passage of the indoor unit 1. In this embodiment, the electrostatic precipitator 3 is provided below the air inlet 21c.

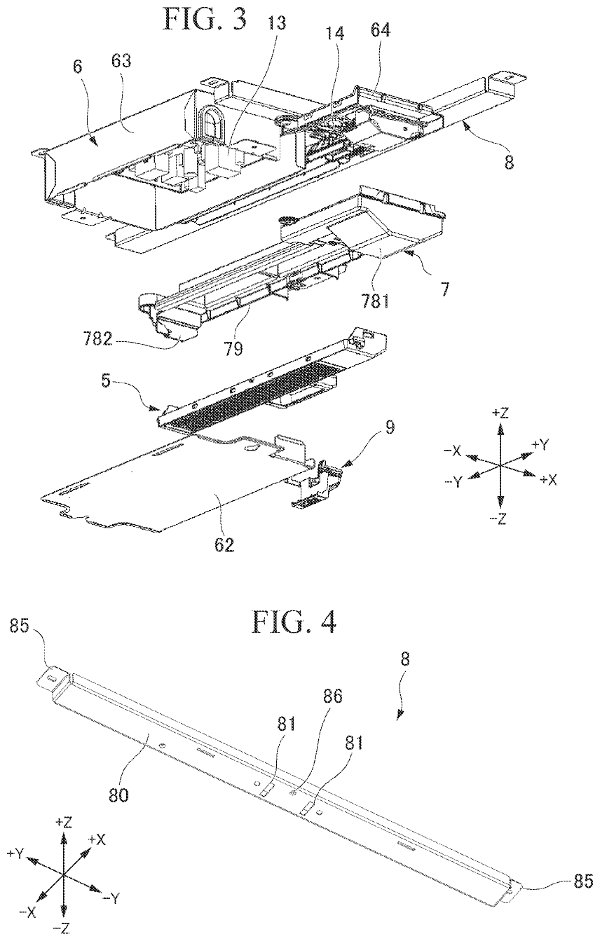

FIG. 3 is an exploded perspective view showing the electrostatic precipitator 3 in the embodiment. As shown in FIGS. 2 and 3, the electrostatic precipitator 3 includes a fixing member 8, a device body 5, a board casing 6, a supporter 7, and a hook member 9. The device body 5 is configured to be switchable between a regular fixed state and a temporarily fixed state. In the regular fixed state, the device body 5 is fixed to the supporter 7. In the temporarily fixed state, the device body 5 is detachably attached to the supporter 7. When the electrostatic precipitator 3 is operated or the decorative panel 24 is attached to the housing 21, the device body 5 is held in a regular fixed state. When the device body 5 is detached from the supporter 7 for the maintenance or the like of the device body 5, the state can be changed to the temporarily fixed state.

FIG. 4 is a perspective view showing the fixing member 8 in the embodiment. As shown in FIG. 4, the fixing member 8 extends in the width direction Y. In this embodiment, the fixing member 8 is a rail-shaped member that opens upward. The fixing member 8 includes a fixing plate 80 which extends in the width direction Y. The fixing plate 80 has a plate shape having a plate surface facing the vertical direction Z. The fixing plate 80 is provided with a pair of first holes 81 penetrating the fixing plate 80 in the vertical direction Z. The first hole 81 is an elongated hole that extends in the front and rear direction X. The pair of first holes 81 is arranged apart from each other in the width direction Y. The pair of first holes 81 is parallel to each other. A screw fixing hole 86 is formed between the pair of first holes 81 of the fixing plate 80 in the width direction Y. Both end portions of the fixing member 8 in the width direction Y are respectively provided with a fixing portion 85. The fixing portion 85 is a portion which is fixed to the housing 21 of the indoor unit 1. The fixing member 8 is fixed by each fixing portion 85 while being suspended over the air inlet 21c of the casing 21b. The electrostatic precipitator 3 is attached to the casing 21b through the fixing member 8.

As shown in FIG. 3, the board casing 6 includes a first attachment portion 63, a second attachment portion 64, and aboard cover 62. The board casing 6 is fixed to the casing 21b via the fixing member 8. A control unit 13 and a voltage generator 14 are attached to the board casing 6. The first attachment portion 63 has a rectangular box shape that opens downward. The control unit 13 is fixed to a wall portion which is located on the upper side in the first attachment portion 63. The control unit 13 includes a control board that controls the operation of the electrostatic precipitator 3. The voltage generator 14 is attached to the second attachment portion 64. The second attachment portion 64 is located on the front side (+X side) of the first attachment portion 63. The second attachment portion 64 extends in the width direction Y. The second attachment portion 64 protrudes toward one side (+Y side) of the width direction Y in relation to the first attachment portion 63. The voltage generator 14 is disposed at a portion protruding toward one side of the width direction Y of the second attachment portion 64 in relation to the first attachment portion 63.

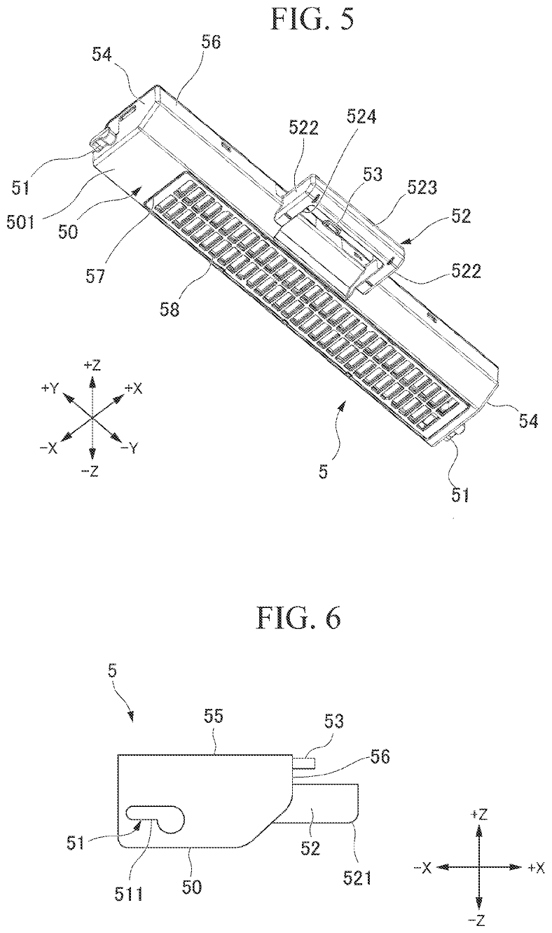

FIG. 5 is a perspective view showing the device body 5 in the embodiment. FIG. 6 is a side view showing the device body 5 in the embodiment. As shown in FIG. 5, the device body 5 includes a device housing 50 and a filter 58. The device housing 50 extends in the width direction Y. The device housing 50 has a box shape that opens upward. A lower bottom surface 501 of the device housing 50 is provided with an opening portion 57 that holds the filter 58. The device housing 50 is made of, for example, resin.

As shown in FIGS. 5 and 6, the device body 5 includes a pair of protrusions 51 that protrudes outward along the width direction Y from both side surfaces (both end side surfaces of the second direction) 54 on both sides of the width direction Y in the device housing 50. Each protrusion 51 is located toward the rear side (−X side) of each side wall 54. The protrusion 51 is located below the center of the device housing 50 in the vertical direction Z. The protrusion 51 includes a guided surface 511 which extends substantially in parallel to the upper surface 55 of the device housing 50. The guided surface 511 is a rear portion in the lower surface of the protrusion 51. The upper surface 55 and the guided surface 511 of the device housing 50 are flat surfaces orthogonal to the vertical direction Z.

The device body 5 includes a handle 52. The handle 52 protrudes toward the front side (+X side) from the substantially center portion of the front surface 56 of the device housing 50 in the width direction Y. As shown in FIG. 5, the handle 52 includes a pair of extending portions 522 which protrudes in the front and rear direction X and a grip portion 521 which connects the extending portions 522. The grip portion 521 extends in the width direction Y. The grip portion 521 and the front surface 56 are away from each other and an opening 524 is formed between the handle 52 and the front surface 56 in the front and rear direction X. The opening 524 opens to a size in which an operator can insert a finger into the opening. The handle 52 is located substantially in the middle of the device housing 50 in the vertical direction Z. The handle 52 is a rectangular handle having a substantially U shape in the plan view.

The device body 5 includes a temporary fixing protrusion 53. The temporary fixing protrusion 53 protrudes toward the front side (+X side) from a portion located on the upper side in relation to the handle 52 in the front surface 56. More specifically, the temporary fixing protrusion 53 protrudes toward the front side from the center of the width direction Y at the upper end portion in the front surface 56. In the width direction Y, the temporary fixing protrusion 53 is located between the extending portions 522 of the handle 52. The front end portion of the temporary fixing protrusion 53 is located on the rear side (−X side) in relation to the grip portion 521. In this embodiment, the position of the temporary fixing protrusion 53 in the width direction Y is included in the position of the handle 52 in the width direction Y. More specifically, the position of the temporary fixing protrusion 53 in the width direction Y includes the position of the width direction Y at the center of the handle 52 in the width direction Y.

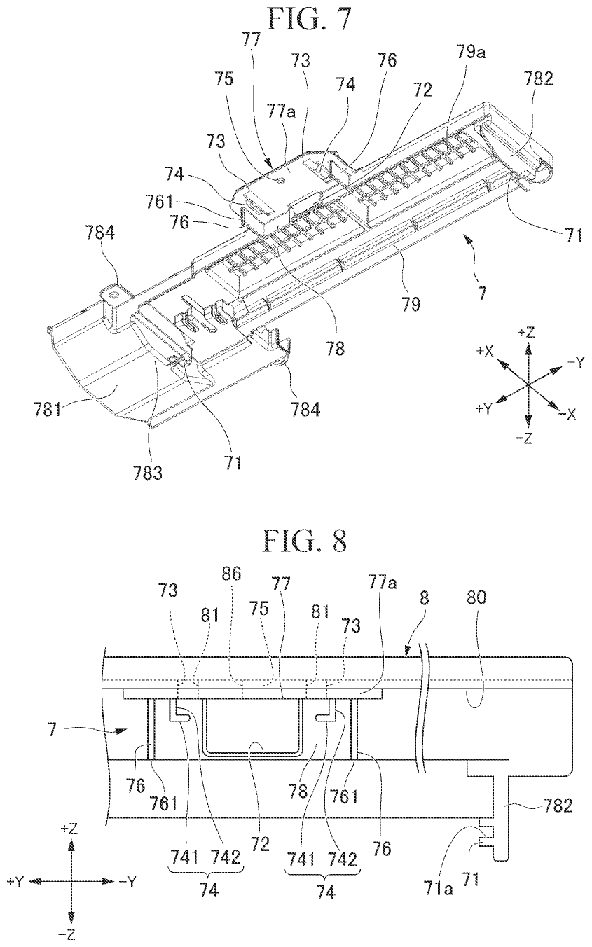

FIG. 7 is a perspective view showing the supporter 7 in the embodiment. FIG. 8 is a schematic view when a part of the supporter 7 and a part of the fixing member 8 in the embodiment are viewed from the front side (+X side). The supporter 7 is a member that is fixed to the fixing member 8. As shown in FIG. 7, the supporter 7 extends in the width direction Y. The supporter 7 is attached below the second attachment portion 64. The supporter 7 includes a covering portion 781 which covers the voltage generator 14 from below. In this embodiment, the covering portion 781 has a container shape that opens upward. The supporter 7 includes an extending portion 79 which extends from the covering portion 781 toward one side (+Y side) of the width direction Y. The extending portion 79 is attached below a portion that is arranged in line on the front side (+X side) of the first attachment portion 63 in the second attachment portion 64. A through-hole 79a that penetrates the extending portion 79 in the vertical direction Z is formed on the extending portion 79.

The supporter 7 includes a pair of wall portions 782 and 783 which faces both end portions of the device body 5 in the width direction Y. The pair of wall portions 782 and 783 is respectively provided at both end portions of the extending portion 79 in the width direction Y. The pair of wall portions 782 and 783 protrudes downward from the end portion of the extending portion 79 in the width direction Y. The wall portion 783 provided at the end portion on one side (+Y side) of the extending portion 79 in the width direction Y also serves as the side wall of the covering portion 781. The wall portion 782 provided on the other side (−Y side) of the extending portion 79 in the width direction Y is a plate-shaped wall that extends downward from the extending portion 79.

The supporter 7 includes a pair of first support portions 71 respectively provided in the pair of wall portions 782 and 783. Each first support portion 71 is provided on the surface facing the other wall portion in each of the pair of wall portions 782 and 783. The first support portion 71 protrudes in the width direction Y from the wall portions 782 and 783. The first support portion 71 has a substantially U shape that opens forward when viewed in the width direction Y.

As shown in FIG. 8, the first support portion 71 includes a flat surface 71a that faces upward. The flat surface 71a extends in the front and rear direction X. The first support portion 71 supports both end portions of the device body 5 in the width direction Y. In this embodiment, the pair of first support portions 71 supports the pair of protrusions 51 from below. More specifically, the guided surface 511 of the protrusion 51 is placed on the flat surface 71a of the first support portion 71 and the protrusion 51 is supported by the first support portion 71 from below.

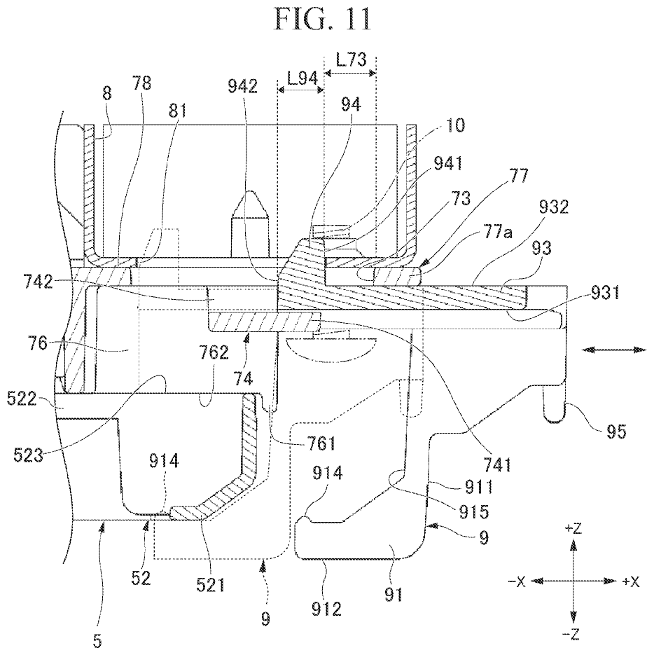

The supporter 7 includes a second support portion 77. The second support portion 77 supports the device body 5 by supporting the handle 52 via the hook member 9. As shown in FIG. 7, the second support portion 77 is located in the middle of the supporter 7 in the width direction Y. The second support portion 77 includes a plate-shaped portion 77a which protrudes from the upper end portion of the extending portion 79 toward the front side (+X side). A fixing hole 75 and a second hole 73 are formed in the second support portion 77. The fixing hole 75 is formed at the front end portion of the plate-shaped portion 77a and the middle in the width direction Y to penetrate the plate-shaped portion 77a in the vertical direction Z. The second hole 73 is an elongated hole that extends in the front and rear direction X. In this embodiment, a pair of the second holes 73 is provided to be apart from each other in the width direction Y. The pair of second holes 73 is arranged to sandwich the fixing hole 75 in the width direction Y. As shown in FIG. 11, the second hole 73 is arranged to face the first hole 81 of the fixing member 8 in the vertical direction Z.

As shown in FIG. 8, the second support portion 77 includes a pair of slide guide portions 74 which protrudes downward from the plate-shaped portion 77a. The pair of slide guide portions 74 respectively supports a pair of protrusions 93 to be described later in the hook member 9 from below. The pair of slide guide portions 74 is arranged apart from each other in the width direction Y. The pair of slide guide portions 74 is arranged on the lower surface of the plate-shaped portion 77a to sandwich the pair of second holes 73 in the width direction Y. The pair of slide guide portions 74 is arranged symmetrically in the width direction Y. Each slide guide portion 74 includes a side wall 742 which protrudes downward from the lower surface of the plate-shaped portion 77a and a receiving portion 741 which protrudes in the width direction Y from the lower end portion of the side wall 742 toward the other slide guide portion 74. Each side wall 742 protrudes downward from the opening edge on the outside of the width direction Y in each of the pair of second holes 73. The distance between the facing surfaces of the side walls 742 of the pair of slide guide portions 74 is slightly larger than the dimension of the upper end portion of the hook member 9 in the width direction Y. Each receiving portion 741 of the pair of slide guide portions 74 is arranged to face the lower side of each of the pair of second holes 73. The distance between the upper surface of the receiving portion 741 and the lower surface of the plate-shaped portion 77a in the vertical direction Z is slightly larger than the thickness of a protrusion 93 to be described later in the hook member 9.

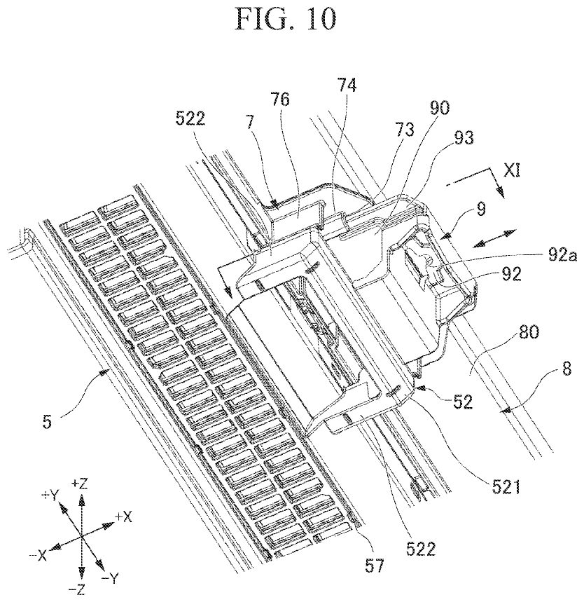

The second support portion 77 includes a pair of protruding wall portions 76. The pair of protruding wall portions 76 is a wall protruding downward from the lower surface of the plate-shaped portion 77a. The pair of protruding wall portions 76 is provided at positions apart from each other in the width direction Y to be parallel to each other along the front and rear direction X. The pair of protruding wall portions 76 is disposed to sandwich the pair of slide guide portions 74 in the width direction Y. The pair of protruding wall portions 76 protrudes downward from the pair of slide guide portions 74. As shown in FIG. 10, the pair of protruding wall portions 76 is respectively located above both end portions of the handle 52 in the width direction Y. As shown in FIG. 7, the end portions on the rear side (−X side) of the pair of protruding wall portions 76 are connected to a front wall portion 78 of the extending portion 79.

As shown in FIG. 11, the lower end of the protruding wall portion 76 contacts with an upper surface 523 of the extending portion 522 in the handle 52. The front end of the protruding wall portion 76 is provided with a stopper 761 protruding downward from the lower end of the protruding wall portion 76. The stopper 761 is located on the front side (+X side) of the upper end portion of the grip portion 521. The forward movement of the handle 52 with respect to the supporter 7 is restricted by the stopper 761.

As described above, in the second support portion 77 of this embodiment, the fixing hole 75 is formed at the center portion of the plate-shaped portion 77a in the width direction Y and the second hole 73, the slide guide portion 74, and the protruding wall portion 76 are provided in this order from the fixing hole 75 toward the outside (both sides) of the width direction Y.

As shown in FIGS. 7 and 8, in this embodiment, the supporter 7 includes a temporary fixing portion 72. The temporary fixing portion 72 is provided in a portion located below the plate-shaped portion 77a in the front wall portion 78. In this embodiment, the temporary fixing portion 72 is a rectangular hole that penetrates the front wall portion 78 in the front and rear direction X. The temporary fixing portion 72 opens between the pair of second holes 73 and the pair of slide guide portions 74. The temporary fixing portion 72 is a hole into which the temporary fixing protrusion 53 of the device housing 50 is inserted. The temporary fixing protrusion 53 inserted into the temporary fixing portion 72 is hooked on the lower edge of the temporary fixing portion 72, and the temporary fixing protrusion 53 is attached to the temporary fixing portion 72.

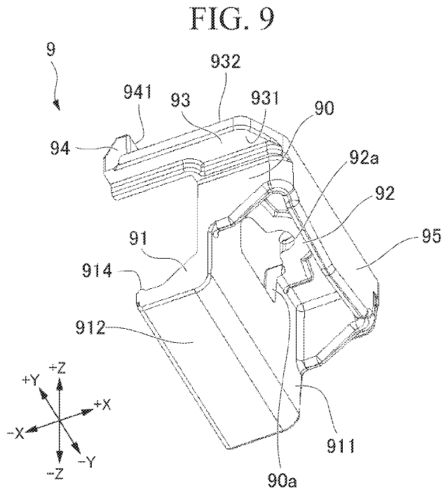

FIG. 9 is a perspective view showing the hook member 9 of this embodiment. FIG. 10 is a perspective view showing a temporarily fixed state of the device body 5. FIG. 11 is a cross-sectional view taken along a line XI-XI of FIG. 10. The hook member 9 is, for example, a component that is integrally formed of resin. The hook member 9 is a member that is attached to the supporter 7 and supports the device body 5 from below. The hook member 9 is attached to the supporter 7 to be slidable in the front and rear direction X. Specifically, the hook member 9 is slidable in the front and rear direction X between the positions indicated by the solid line in FIG. 11 and the position indicated by the dashed line in FIG. 11. The position of the hook member 9 indicated by the solid line in FIG. 11 is the position of the hook member 9 in the temporarily fixed state and is the position in which the device body 5 is detachable from the supporter 7. The position of the hook member 9 indicated by the dashed line in FIG. 11 is the position of the hook member 9 in the regular fixed state and is the position in which the engagement between the device body 5 and the supporter 7 is maintained. In this way, the hook member 9 is attached to the supporter 7 to be slidable between the position in which the engagement between the device body 5 and the supporter 7 is maintained and the position in which the device body 5 is detached from the supporter 7.

As shown in FIG. 9, the hook member 9 includes a base portion 90, a hook portion 91, a pair of protrusions 93, and a pair of claw portions 94. The base portion 90 has a substantially rectangular parallelepiped box shape that opens downward. The center portion of the width direction Y of the wall portion located on the upper side in the wall portion constituting the base portion 90 is a screw fixing portion 92. The screw fixing portion 92 is provided with a hole portion 92a through which a screw 10 fixing the hook member 9 to the fixing member 8 passes.

An opening 90a penetrating the wall portion in the front and rear direction X is formed in the wall portion located on the rear side (−X side) in the wall portion constituting the base portion 90. The opening 90a opens to be continuous to the hole portion 92a of the screw fixing portion 92. The wall portion located on the front side (+X side) in the wall portion constituting the base portion 90 is a hook handle 95. The hook handle 95 extends in the width direction Y. The hook handle 95 is a portion which is gripped by the operator who slides the hook member 9 in the front and rear direction X. The operator can grip the hook handle 95 by inserting a finger into the base portion 90 from below.

The hook portion 91 is connected to the lower side of the wall portion located on the rear side (−X side) in the wall portion constituting the base portion 90. The hook portion 91 includes a vertical wall portion 911 and a lower support portion 912. The vertical wall portion 911 extends downward from the wall portion located on the rear side in the wall portion constituting the base portion 90. The lower support portion 912 extends backward from the lower end portion of the vertical wall portion 911. As indicated by the dashed line in FIG. 11, the lower support portion 912 supports the grip portion 521 from below in the regular fixed state. Accordingly, the hook member 9 supports the device body 5 from below.

The rear end portion of the lower support portion 912 is provided with a locking protrusion 914 which protrudes upward (+Z side). The upper end of the locking protrusion 914 is located above the lower end of the grip portion 521. The locking protrusion 914 is hooked by the lower end portion of the grip portion 521 from the rear side (−X side) in the regular fixed state. Accordingly, the locking protrusion 914 can suppress the grip portion 521 from moving backward with respect to the hook member 9.

A contact portion 915 is formed on the surface on the rear side (−X side) of the hook portion 91. The contact portion 915 faces the surface on the front side (+X side) of the grip portion 521 in the front and rear direction X. The contact portion 915 has a shape along the front surface of the grip portion 521. The contact portion 915 contacts the front surface of the grip portion 521 in the regular fixed state.

As shown in FIG. 9, the pair of protrusions 93 respectively protrudes from the upper end portion of the base portion 90 toward both sides of the width direction Y. In this embodiment, the pair of protrusions 93 extends toward the rear side (−X side) in relation to the base portion 90. The rear end portions of the pair of protrusions 93 are located on the rear side of the rear end portion of the lower support portion 912. Each of the pair of protrusions 93 includes an upper surface 932 and a lower surface 931 which follow the front and rear direction X and the width direction Y.

The pair of claw portions 94 is respectively provided in the pair of protrusions 93. Each claw portion 94 is formed to protrude upward (+Z side) from the rear end portion in the upper surface 932 of each protrusion 93. As shown in FIG. 11, a front surface 941 and a rear surface 942 of the claw portion 94 are formed along the vertical direction Z. The upper portion of the rear surface 942 is an inclined surface which is located on the front side (+X side) as it goes upward.

Although not shown in the drawings, the electrostatic precipitator 3 includes a dust collection mechanism having a dust collection electrode, a power supply terminal, a power reception terminal, and the like. When the air conditioner 200 is operated, a high voltage is applied from the voltage generator 14 to the dust collection electrode via the power supply terminal and the power reception terminal. Accordingly, the electrostatic precipitator 3 is operated to collect air dust and the like sucked into the housing 21 of the indoor unit 1.

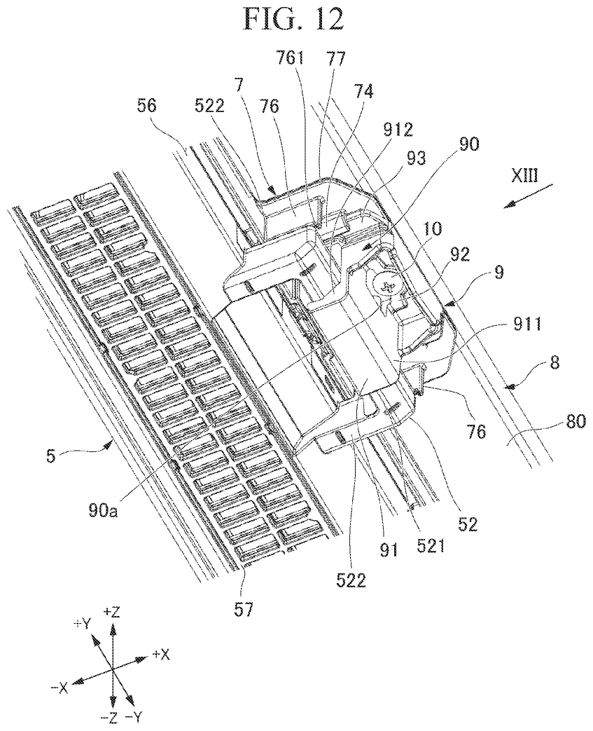

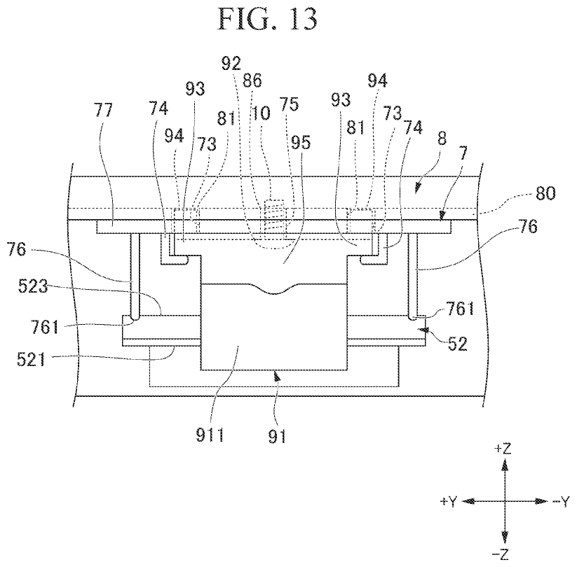

Next, the attachment structure of the electrostatic precipitator 3 will be described in more detail. FIG. 12 is a perspective view showing the regular fixed state of the device body 5. FIG. 13 is a front view when viewed from a direction of an arrow XIII of FIG. 12. The fixing portion 85 of the fixing member 8 is fixed to the housing 21. The fixing member 8 is installed over the air inlet 21c. As shown in FIG. 3, the board casing 6 is fixed to the fixing member 8. The supporter 7 is fixed to the board casing 6 or the fixing member 8 by a screw. As shown in FIGS. 12 and 13, the upper surface of the second support portion 77 faces and contacts the lower surface of the fixing plate 80 of the fixing member 8. At this time, the second hole 73 of the second support portion 77 is located below the first hole 81 of the fixing member 8. The second hole 73 of the second support portion 77 and the first hole 81 of the fixing plate 80 are arranged at the positions overlapping the vertical direction Z and the claw portion 94 passes through the first hole 81 and the second hole 73 in the vertical direction Z. In this state, the hook member 9 is attached to the second support portion 77.

The hook member 9 is attached to the fixing member 8 together with the supporter 7 while the pair of protrusions 93 is supported from below by the pair of slide guide portions 74. At this time, the claw portion 94 of the hook member 9 passes through the first hole 81 of the fixing member 8 from below. When the pair of protrusions 93 of the hook member 9 slides on the pair of slide guide portions 74 in the front and rear direction X, the claw portion 94 also slides in the front and rear direction X inside the first hole 81 and the second hole 73.

In a state that the hook member 9 is locked to the slide guide portion 74, the screw 10 is inserted into the base portion 90 from below, passes through the hole portion 92a of the screw fixing portion 92 of the hook member 9 and the fixing hole 75 of the second support portion 77, and the screw 10 is threaded into the screw fixing hole 86 of the fixing member 8. In the case of the temporarily fixed state, the screw 10 is not fully tightened and is loosened to the extent that the screw does not fall off. In this state, the hook member 9 is attached to the supporter 7 while being slidable in the front and rear direction X with respect to the supporter 7. When the hook member 9 moves in the front and rear direction X, the screw head portion of the screw 10 can pass through the wall portion on the rear side (−X side) of the base portion 90 in the front and rear direction X, for example, through the opening 90a.

As shown in FIG. 11, the length L94 of the front surface 941 and the rear surface 942 of the claw portion 94 in the front and rear direction X, that is, the dimension of the claw portion 94 in the front and rear direction X is larger than the distance between the end portion on the front side (+X side) of the first hole 81 of the fixing member 8 and the end portion on the front side of the slide guide portion 74 in the front and rear direction X. Therefore, the claw portion 94 is located on the slide guide portion 74 while contacting the edge portion on the front side of the first hole 81 (one side of the first direction). Accordingly, the claw portion 94 is limited to move forward to a position that the claw portion 94 is disengaged from the slide guide portion 74. Thus, the claw portion 94 is capable of being suppressed from being hooked to the front edge of the first hole 81 so that the hook member 9 is suppressed from being disengaged from the supporter 7 toward the front side.

The operator who maintains the device body 5 temporarily fixes the device body 5 to the supporter 7 while the hook member 9 is slidable in the front and rear direction X. Specifically, the operator brings the device body 5 close to the supporter 7 from below, arranges the guided surfaces 511 of the pair of protrusions 51 on the pair of first support portions 71, and supports the pair of protrusions 51 from below by the pair of first support portions 71. Further, the operator inserts the temporary fixing protrusion 53 of the device housing 50 into the temporary fixing portion 72 of the supporter 7 from the rear side toward the front side, and supports the temporary fixing protrusion 53 to the temporary fixing portion 72 from below. Accordingly, the device body 5 is supported by the supporter 7 from below, and the device body 5 is temporarily fixed to the supporter 7. At this time, as shown in FIG. 11, the lower ends of the pair of protruding wall portions 76 of the second support portion 77 contact the upper surface 523 of the extending portion 522 of the handle 52. Accordingly, the height of the handle 52 is positioned by the pair of protruding wall portions 76. The handle 52 is positioned at a height at which the hook member 9 can support the handle 52 from below.

When the device body 5 is temporarily fixed to the supporter 7, the device body 5 is held while being attached to the supporter 7 even when the operator releases hands from the device body 5. In this state, the operator grips the hook handle 95, slides the hook member 9 toward the rear side (−X side), and supports the grip portion 521 of the handle 52 from below by the lower support portion 912 of the hook portion 91. The operator fully tightens the screw 10 while supporting the grip portion 521 from below by the hook portion 91. Accordingly, the hook member 9 is fixed to the supporter 7 and the fixing member 8 not to be slidable in the front and rear direction X. Therefore, the handle 52 of the device body 5 is capable of being preferably held while being supported from below by the hook member 9 and the device body 5 is capable of being regularly fixed to the supporter 7 and the fixing member 8. Additionally, in this embodiment, the hook member 9 and the supporter 7 are jointly fastened to the fixing member 8 by the screw 10.

According to this embodiment, the device body 5 includes the handle 52 protruding in the front and rear direction X and a pair of protrusions 51 protruding from both end side surfaces of the width direction Y orthogonal to the front and rear direction X. The supporter 7 includes a pair of first support portions 71 which is used to hook the pair of protrusions 51 thereto and respectively supports the pair of protrusions 51. The hook member 9 includes a hook portion 91 which supports the handle. Therefore, the device body 5 is capable of being temporarily fixed to the supporter 7 by hooking the pair of protrusions 51 to the pair of first support portions 71, and in this state, the device body 5 is capable of being regularly fixed to the supporter 7 in a stable manner by supporting the handle 52 in such a manner that the hook portion 91 is fixed. Accordingly, for example, even when the support of the device body 5 by the hook member 9 is released when detaching the device body 5 for maintenance or the like, a state in which the device body 5 is temporarily fixed by the pair of protrusions 51 is capable of being maintained and the device body 5 is preferably suppressed from falling off. The device body 5 is capable of being stably fixed to the supporter 7 in the regular fixed state in which the device body 5 is supported by the hook member 9. Therefore, the regular fixed device body 5 is preferably suppressed from falling off. As described above, according to this embodiment, the workability of attaching and detaching the device body 5 to and from the indoor unit 1 is possible to be improved.

According to this embodiment, the handle 52 includes a pair of extending portions 522 protruding in the front and rear direction X and a grip portion 521 which connects each of the extending portions 522. The hook portion 91 supports the grip portion 521 from below. Therefore, the device body 5 can be more stably supported by the hook portion 91 and the device body 5 which is regularly fixed is more preferably suppressed from coming off.

According to this embodiment, the hook member 9 is attached to the supporter 7 to be slidable in the front and rear direction X. Therefore, when the hook member 9 is moved in the front and rear direction X as described above, it is possible to switch between a state in which the hook member 9 supports the handle 52 of the device body 5 and a state in which the hook member 9 does not support the handle 52 of the device body 5. Accordingly, it is possible to easily switch between a state in which the device body 5 is temporarily fixed and a state in which the device body 5 is regularly fixed.

According to this embodiment, the supporter 7 includes the second support portion 77 which supports the hook member 9. The hook member 9 includes the pair of protrusions 93 which respectively protrudes from both sides of the width direction Y. The second support portion 77 includes the pair of slide guide portions 74 which respectively supports the pair of protrusions 93 from below to be slidable in the front and rear direction X. Therefore, the hook member 9 is capable of being fixed to the supporter 7 to be movable in the front and rear direction X in a more stable state. Accordingly, the hook member 9 slides easily in the front and rear direction X and the workability of attaching and detaching the device body 5 to and from the indoor unit 1 is further improved.

According to this embodiment, the second support portion 77 is disposed to face the lower side of the fixing member 8. The fixing member 8 is provided with the first hole 81 which extends in the front and rear direction X. The second support portion 77 is provided with the second hole 73 which extends in the front and rear direction X to face the first hole 81. The hook member 9 includes the claw portion 94 which protrudes upward from the protrusion 93. The claw portion 94 is located on the slide guide portion 74 while passing through the first hole 81 and the second hole 73 and contacting the edge portion on the front side of the first hole 81 (one side of the first direction). Therefore, as described above, the claw portion 94 is capable of being suppressed from being hooked to the front edge of the first hole 81 so that the hook member 9 is disengaged from the supporter 7 toward the front side. Accordingly, the hook member 9 is capable of being suppressed from falling off from the supporter 7 and the hook member 9 slides more preferably in the front and rear direction X. Thus, the workability of attaching and detaching the device body 5 to and from the indoor unit 1 is further improved.

According to this embodiment, the hook member 9 includes the screw fixing portion 92 which is fixed to the supporter 7 by the screw 10. The hook member 9 is slidable with respect to the supporter 7 while the fixing of the screw fixing portion 92 using the screw 10 is released. Therefore, the hook member 9 can be made slidable in the front and rear direction X by loosening the screw 10 and the hook member 9 can be made non-slidable in the front and rear direction X by tightening the screw 10. Accordingly, it is possible to more easily switch between a state in which the hook member 9 is movable in the front and rear direction X and a state in which the hook member 9 is fixed to the supporter 7 and the fixing member 8 and is not movable in the front and rear direction X. Further, the hook member 9 can be firmly fixed by the screw 10.

According to this embodiment, the device body 5 includes the temporary fixing protrusion 53. The supporter 7 includes the temporary fixing portion 72 to which the temporary fixing protrusion 53 is locked. The position of the temporary fixing protrusion 53 in the width direction Y is included in the position of the handle 52 in the width direction Y. Therefore, when the device body 5 is temporarily fixed to the supporter 7, the temporary fixing protrusion 53 is capable of being supported even by the temporary fixing portion 72 in addition to the support of the pair of protrusions 51 by the pair of first support portions 71. Further, since the position of the temporary fixing protrusion 53 in the width direction Y is included in the position of the handle 52 in the width direction Y, the device body 5 is capable of being stably supported in the width direction Y in a balanced manner by supporting the pair of protrusions 51 and the temporary fixing protrusion 53. Accordingly, the device body 5 is capable of being temporarily fixed more stably. Thus, the device body 5 is capable of being more stably suppressed from falling off during maintenance or the like.

According to this embodiment, the electrostatic precipitator, the indoor unit, and the air conditioner having excellent attachment and detachment workability is capable of being provided.

According to this embodiment, the hook member 9 is slidable with respect to the supporter 7 while the fixing of the hook member 9 at the screw fixing portion using the screw 10 is released and the hook member 9 fixes the engagement position of the device body 5 with respect to the supporter 7 while being fixed by the screw 10. Thus, the state in which the hook member 9 is slidable or fixed is switched only by the operation of turning the screw 10. Since the hook member 9 is fixed to the supporter by the screw, the hook member is slidable when the screw 10 is loosened. Thus, since it is not necessary to detach the screw 10 during maintenance, the workability is excellent.

According to the embodiment, a screw hole is formed in the thickness direction to penetrate each of the fixing plate, the second support portion, and the screw fixing portion, the screw 10 is inserted into each screw hole from below, and the hook member and the supporter are threaded to the fixing member. That is, the device body and the supporter are fixed to the fixing plate at the same position by the screw. Therefore, the device body is stably supported without being displaced from the supporter in the regular fixed state in which the device body which is attached to the fixing plate, the second support portion, the hook member, and the hook member are regularly fixed by the screw 10. As a result, effects such as maintaining the energized state of the device body and preventing vibration are obtained. In addition, since a fixing operation or a fixing release operation of the device body and the supporter with respect to the fixing plate is capable of performing by operating the screw 10, the convenience in operation is high.

According to this embodiment, since the indoor unit includes the device body 5 that prevents the device body from falling off during installation or maintenance and is easily fixed temporarily or regularly, a highly convenient indoor unit is capable of being provided.

Although the embodiment in the present disclosure has been described above, the present disclosure is not limited only to the configuration of the above-described embodiment and the following configuration and method can be also employed. In the embodiment, an example is shown in which the pair of wall portions 782 and 783 protrudes from the facing surfaces to form the first support portion 71, and the first support portion 71 supports the guided surface 511 of the protrusion 51 of the device body 5 from below, but the configuration in which the first support portion supports the device body is not limited thereto. For example, a protrusion may be provided at the lower end portion of the device body, a receiving portion supporting the lower end portions at both ends of the device body in the width direction Y may be formed on an inner wall, and both end portions of the device body in the width direction Y may be supported from below.

In this embodiment, an example is shown in which the second hole 73 of the second support portion 77 is configured as a pair of elongated holes formed to be apart from each other in the width direction Y, the second hole is not limited to this form. The second hole may have a shape in which at least a part of the opening edge extends linearly in the front and rear direction X so that the second hole can guide the hook member 9 to be slidable in the front and rear direction X. The second hole may guide the hook member 9 to be slidable in the front and rear direction X and the second hole may be formed at one position of the second support portion 77.

In the embodiment, an example has been shown in which the supporter 7 and the hook member 9 are different components, but the supporter may be provided with the hook portion. For example, the supporter and the hook portion may be integrally formed with each other.

As described above, each configuration and each method described in this specification can be appropriately combined as long as they do not contradict each other.

1. An electrostatic precipitator provided in an indoor unit of an air conditioner, comprising:
a casing attached to a housing of the indoor unit;
a fixing member attached to the casing;
a supporter attached to the fixing member;
a device body supported by the supporter and is detachably attached to the supporter; and
a hook member supporting the device body,
wherein the device body includes a handle protruding in a first direction and a pair of protrusions protruding from both end side surfaces of the delivery body in a second direction orthogonal to the first direction,
the supporter includes a pair of first support portions respectively supporting the pair of protrusions by hooking the pair of protrusions,
the hook member includes a hook portion supporting the handle,
the handle includes a pair of extending portions which protrudes in the first direction and a grip portion which connects the extending portions,
the hook portion supports the grip portion from below, and
the hook member is attached to the supporter so as to be slidable in the first direction.

2-3. (canceled)

4. The electrostatic precipitator according to claim 1,
wherein the supporter includes a second support portion supporting the hook member,
the hook member includes a pair of protrusions which respectively protrudes from both sides of the hook member in the second direction, and
the second support portion includes a pair of slide guide portions which respectively supports the pair of protrusions from below so as to be slidable in the first direction.

5. The electrostatic precipitator according to claim 4,
wherein the second support portion is disposed to face the lower side of the fixing member;
the fixing member is provided with a first hole extending in the first direction,
the second support portion is provided with a second hole which faces the first hole and extends in the first direction,
the hook member includes a claw portion protruding upward from the protrusion, and
the claw portion is located on the slide guide portion in a state that the claw portion passes through the first hole and the second hole and contacts one edge portion of the first hole in the first direction.

6. The electrostatic precipitator according to claim 1,
wherein the hook member includes a screw fixing portion fixed to the supporter by a screw, and
the hook member is slidable with respect to the supporter while the fixing of the screw fixing portion using the screw is released.

7. The electrostatic precipitator according to claim 1,
wherein the device body includes a temporary fixing protrusion,
the supporter includes a temporary fixing portion to which the temporary fixing protrusion is locked, and
a position of the temporary fixing protrusion in the second direction is included in a position of the handle in the second direction.

8. An indoor unit comprising:
a housing;
a heat exchanger accommodated in the housing;
an air supply mechanism accommodated in the housing; and
the electrostatic precipitator according to claim 1 attached to the housing.

9. An air conditioner comprising:
the indoor unit according to claim 8; and
an outdoor unit connected to the indoor unit by a circulation path portion through which a refrigerant circulates.

10. An electrostatic precipitator provided in an indoor unit of an air conditioner, comprising:
a casing attached to a housing of the indoor unit;
a fixing member attached to the casing;
a supporter attached to the fixing member;
a device body supported by the supporter and is detachably attached to the supporter; and
a hook member supporting the device body,
wherein the device body includes a handle protruding in a first direction and a pair of protrusions protruding from both end side surfaces of the delivery body in a second direction orthogonal to the first direction,
the supporter includes a pair of first support portions respectively supporting the pair of protrusions by hooking the pair of protrusions,
the hook member includes a hook portion supporting the handle,
the hook member includes a vertical wall portion extended downward and a lower support portion extended backward from a lower end portion of the vertical wall portion, and
the lower support portion supports the handle from below.

11. The electrostatic precipitator according to claim 10,
wherein a locking protrusion protruding upward is formed at a rear end portion of the lower support portion.

12. The electrostatic precipitator according to claim 10,
wherein the supporter includes a second support portion supporting the hook member,
the hook member includes a pair of protrusions which respectively protrudes from both sides of the hook member in the second direction, and
the second support portion includes a pair of slide guide portions which respectively supports the pair of protrusions from below so as to be slidable in the first direction.

13. The electrostatic precipitator according to claim 10,
wherein the second support portion is disposed to face the lower side of the fixing member;
the fixing member is provided with a first hole extending in the first direction,
the second support portion is provided with a second hole which faces the first hole and extends in the first direction,
the hook member includes a claw portion protruding upward from the protrusion, and
the claw portion is located on the slide guide portion in a state that the claw portion passes through the first hole and the second hole and contacts one edge portion of the first hole in the first direction.

14. The electrostatic precipitator according to claim 10,
wherein the hook member includes a screw fixing portion fixed to the supporter by a screw, and
the hook member is slidable with respect to the supporter while the fixing of the screw fixing portion using the screw is released.

15. The electrostatic precipitator according to claim 10,
wherein the device body includes a temporary fixing protrusion,
the supporter includes a temporary fixing portion to which the temporary fixing protrusion is locked, and
a position of the temporary fixing protrusion in the second direction is included in a position of the handle in the second direction.
